(19) United States
(12) Patent Application Publication
(10) Pub. No.: US 2023/0411739 A1
(43) Pub. Date: Dec. 21, 2023

(54) Inverse Hybrid Cell

(71) Applicant: Chance BONAVENTURA, Las Vegas, NE (US)

(72) Inventor: Chance BONAVENTURA, Las Vegas, NE (US)

(21) Appl. No.: 17/842,797

(22) Filed: Jun. 17, 2022

(51) Int. Cl. H01M 12/02

(52) U.S. Cl. CPC H01M 12/02

(57) ABSTRACT

A general problem with all batteries of the primary, secondary, and “reserve” kind is the fact that they lose charge and “idle” away their useful life. The need to monitor primaries and to recharge and watch over secondaries has, as of yet, not been obviated by electrochemical or metallurgical breakthroughs. This invention provides for the use of a long-lived cell, for example, of modern lithium design, which is encapsulated within, or without, any battery case or system and connected by means of a resistor to “polarize” the primary, activated reserve, or secondary cells whose life one wishes to extend. Experimental tests sufficiently determine, for various cells, that the amount of current required to polarize the primary and secondary electrodes prevents dissolution of the anode (oxidation) and reduction of the cathode. A reserve cell can be activated by providing electrolyte, electrode proximity, etc., and yet be prevented from running down by applying the aforesaid polarizing (keeping) potential. This will further the progress of applying hybrid cells and hybrid systems (Pat App no. 848224) to a wide sphere of activity because of the ability to hold, then activate the reserve cells by switching the hybrid front cell potential. This invention may also eliminate cumbersome methods of activating and efficiently using reserve cells, especially those of the active light metal kind.

By monitoring the polarization of activated cells, applying a “keeping” potential to selected cells, one may increase efficiency, life, and practicability of hybrid cell systems. With the pervasiveness of secondary (lithium) batteries in electronics, cars, emergency power banks, etc.; this method will allow for integrated or non-integrated improvements to such systems. For example, one can now integrate a “disposable”, reactive light metal reserve component into an electric vehicle (thus eliminating the need of traditional recharging); as such systems already contain adequate computing & secondary battery components to enable the practicability of such inverse hybrid system designs.

### BACKGROUND OF THE INVENTION

The state-of-the-art of primary, secondary and reserve cells is well summarized in the literature and in former patents issued, and applications filed. As referenced in related patent application, “Hybrid Cell”, excellent details are provided by the Journal of the Electrochemical Society, the proceedings of the Power Source Symposia, and in NASA Conference proceedings.

Yet always we have had the problem that once any cell is activated whether primary, secondary, or reserve, the cell begins to lose its potential energy due to internal electro-chemical processes. Until now there has not been a simple and satisfactory way to slow down or stop such processes.

The reason batteries work is because anode materials dissolve into electrolytes. This is the same reason iron tanks corrode away into the ground. To stop corrosion reactions, one can apply an emf source to the plate or tank which is to be protected. For example, a magnesium electrode hooked via a wire to the iron tank. Now the magnesium does the dissolving, delivering electrons to the iron tank or anode to be protected. Since the anode to be protected does not, or need not, know the source of its applied potential nor its source of electrons, to prevent corrosion and dissolution of any primary cell, one can apply an external potential to it, controlling the “polarization” of the primary cell by appropriate series resistors.

### DESCRIPTIONS OF THE DRAWINGS

FIG. 1: Shows the basic configuration designed to achieve passivation, with the secondary cell connected by means of a resistor to the cell to be passivated.

FIG. 2: Shows an embodiment of the invention whereby a thin passivating cell is placed at the negative end of a typical primary cell.

FIG. 3: Shows a basic configuration of the invention whereby a secondary cell is utilized as the passivating mechanism in a hybrid-cell(internally incorporated reserve cell)system; which is then activated by non-mechanical methods, and passivated by the same via reversing polarity via microprocessor control by an incorporated secondary cell potential and resistors (resulting in an “inverse” hybrid state).

### THE INVENTION

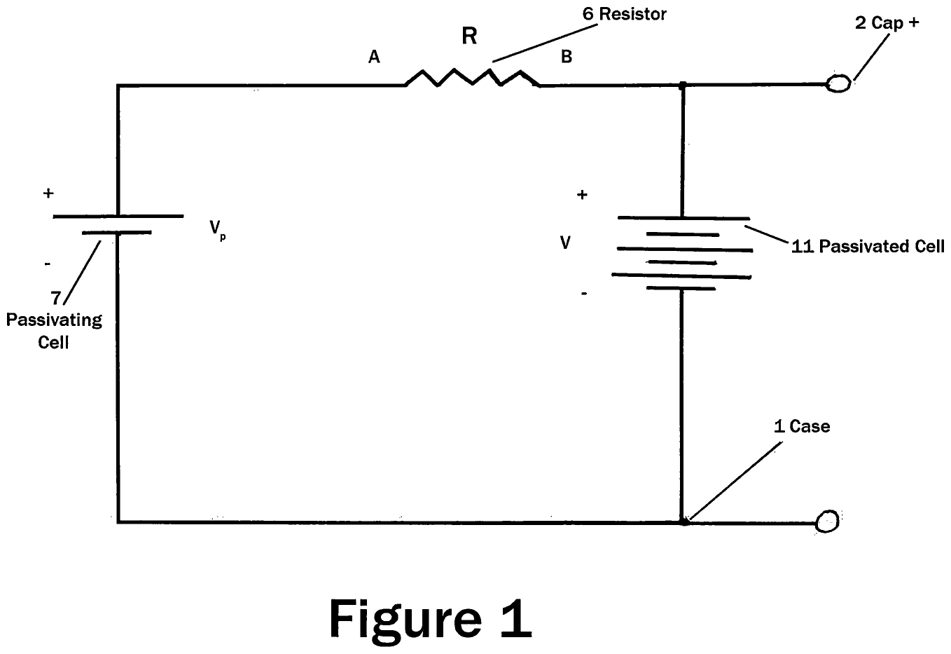

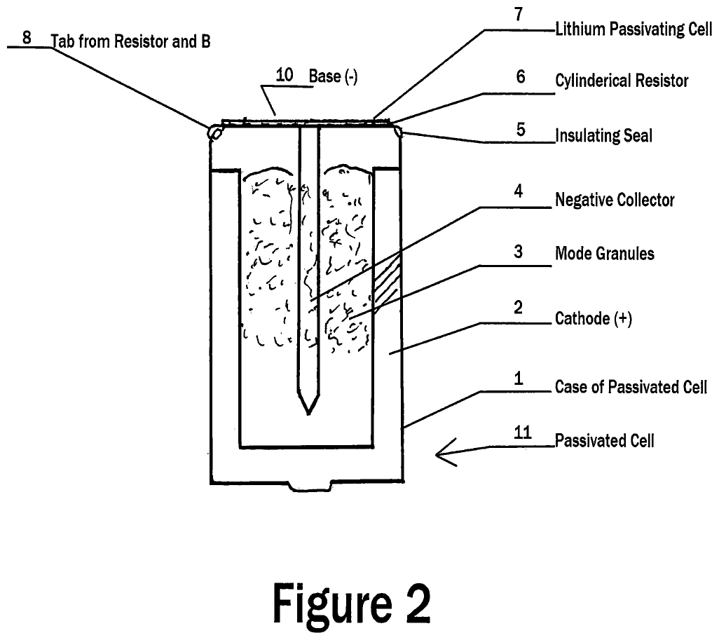

Reference to FIGS. 1, 2, and 3 will enable one to understand the invention. In FIG. 2, a thin, long-lived passivating cell 7 has been added to a conventional alkaline cell 11 (passivated cell). Inside cell 7, a cylindrical wafer of resistance R (6) connects, through tab 8, the positive terminal of passivating cell 7 to the positive terminal of the passivated cell 11. FIG. 1 shows resistor R (6) connected at A to cell 7 and at B to the positive terminal (Case 1) of cell 11. The negative terminal of cell 7 is connected to the negative terminal of cell 11 through direct physical contact of the negative terminals of each cell. We note that the negative terminals of cells 11 and 7 are insulated 5 from the positive case terminal 1 of cell 11.

A naive calculation may help to convey the order of magnitude method of determining the value of the Resistor R (6) to effect passivation of cell [11].

Imagine a 10 A-hr cell loses half its charge in 12 months. This is the equivalent of an average discharge current as determined by:

$$\frac{5 coulombs}{sec} * 1 hr = i * 12 * 30 * 24$$

$$yielding i = \text{.6} ma$$

If Vp of cell 7 is 3V, R=3+0.6=5k

Thus, the order of magnitude of i and R are not difficult to obtain.

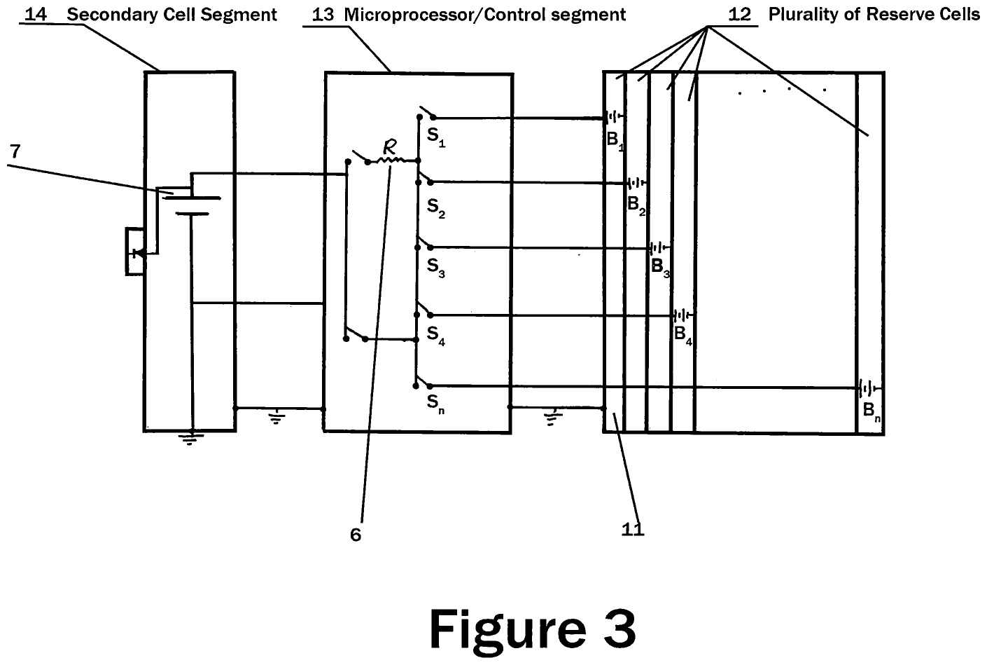

In FIG. 3, B1, B2, . . . Bn are a plurality of reserve cells 12, which are passivated in turn, as switches S1, S2 . . . Sn are activated by the microprocessor-monitor control segment 13, a long-lived passivating cell 7, already serving as a secondary cell segment(rechargeable) 14 in a hybrid-cell system provides the polarizing field and is controlled via microprocessor 13 and incorporated resistor(s) 6 to passivate selected reserve sections 12 (passivated cell(s) 11); and

The effectiveness of this simple argument can be improved by making certain design changes within the body of a battery. In certain embodiments, the passivating cell materials will be distributed within the regions of cell activity to improve the efficiency of passivation.

What is claimed:

1: A battery consisting of the main, passivated cell, of voltage V and a second battery, passivating cell, with voltage Vp greater than V, the two being encased in a common container or they may be in separate containers, the cell of larger voltage being connected to the cell to be preserved or life extended by means of a resistor in such polarity as to provide an electric polarizing field inside the passivated cell. That is, the positive terminal or plate of the smaller passivating cell of voltage Vp>V is connected through the resistor to the positive terminal of the cell to be passivated (of voltage V), and the negative terminals are connected together.

2: A battery as set forth in claim 1, wherein said passivating cell is external to the main cell to be passivated—(life extended).

3: A battery as set forth in claim 1 wherein the passivating cell and resistor are contained inside the case of the main cell to be passivated.

4: A battery as set forth in claims 1, 2, and 3 wherein the passivating cell delivers no current (and thus is not charging the passivated cell).

5: A battery as set forth in claims 1, 2, 3, and 4 wherein small currents are supplied to the cell to be passivated by the passivating cell.

6: A battery as set forth in claims 1, 2, 3, 4, and 5 wherein a passivating cell is incorporated into a hybrid-cell system, either externally, or internally; and controlled via a microprocessor to passivate selected cell sections individually, in plurality, or both.

7: A battery as set forth in claims 1, 2, 3, 4, 5, and 6 wherein the passivating cell, controlled under microprocessor control, serves as the mode of activation, storage, and passivation of reserve cells.
